(19) United States
(12) Patent Application Publication
(10) Pub. No.: US 2014/0136256 A1
(43) Pub. Date: May 15, 2014

(54) Methods for Identifying Subject Matter Expertise Across An Organization Hierarchy

(71) Applicant: OrgSpan, Inc., Durham, NC (US)

(72) Inventor: Donald Brown, Indianapolis, IN (US)

(73) Assignee: OrgSpan, Inc., Durham, NC (US)

(21) Appl. No.: 14/081,474

(22) Filed: Nov. 15, 2013

Related U.S. Application Data
(60) Provisional application No. 61/726,721, filed on Nov. 15, 2012.

(51) Int. Cl. G06Q 10/06

(52) U.S. Cl. CPC G06Q 10/063112
USPC 705/7.14

(57) ABSTRACT

Methods for creating, arranging, and leveraging an ad-hoc collection of organization components are provided. In one example, a method includes the steps of receiving a support request and identifying an organization process associated with the support request. The method includes the additional steps of identifying an organization member associated with the identified organization process and displaying a list of organization members with the highest ranking expertise in the identified organization process.

### CROSS-REFERENCE TO RELATED APPLICATIONS

This application claims priority to U.S. Provisional Application No. 61/726,721, filed 15 Nov. 2012 and entitled “METHODS FOR IDENTIFYING SUBJECT MATTER EXPERTISE ACROSS AN ORGANIZATION HIERARCHY”, the contents of which are incorporated herein as if set forth in full.

### FIELD

This invention relates generally to enterprise applications, and more specifically to methods for identifying subject matter expertise across an organization hierarchy.

### BACKGROUND

In large organizations, managers struggle to identify the right person to handle a new problem or task. To begin with, the actual skills and experiences implicated by a new problem or issue may be hard to ascertain at first glance. Even when the nature of a problem is understood, managers may have no system for tracking or discovering which organization members have experience in the same or similar subject matters as the new problem.

As a result, in traditional organization managers are forced to rely on their own limited memory and ineffective word-of-mouth for assembling a team to tackle the new issue. New problems may be inefficiently assigned to employees with little or no expertise related to the task at hand, while other employees with matching expertise go underutilized. Thus there is a need for new methods to solve recurring organization problems.

### SUMMARY

Embodiments of the invention provide methods for identifying subject matter expertise across an organization hierarchy. An exemplary system may allow a user to navigate or search an organization hierarchy and identify the best people based on what task that user is trying to accomplish. The system may identify and track which organization members are responsible for different organization processes and allow users to quickly find the right person for a particular task. The system may include a learning component that automatically identifies each member's expertise based on stored profile information, as well as a manual entry component that lets users publicly or privately designate certain members as experts in a particular area.

In another aspect, a method for identifying subject matter expertise across an organization hierarchy comprises receiving an input associated with a new task, and identifying one or more subject matters associated with the new task. The method further comprises generating a list of organization members with expertise in the identified subject matters.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a flow chart illustrating a method according to another embodiment.

FIG. 4 is a flow chart illustrating a method according to another embodiment.

FIG. 5 is a diagram illustrating a system according to an embodiment.

FIGS. 6-8 are screenshots screenshot illustrating embodiments for identifying subject matter expertise across an organization hierarchy.

### DETAILED DESCRIPTION

Embodiments are described for identifying subject matter experts across an organization hierarchy. According to embodiments, organization members may quickly and easily find the right person for a new task. Search queries may be analyzed to identify relevant subject matters associated with a problem or task, and a list of relevant organization members may be generated. Further, assignment and delegation is enhanced by automatically identifying and tracking latent and hidden areas of expertise across an organization.

In one exemplary embodiment an organization hierarchy application generates an organization hierarchy. The application displays the hierarchy, including a plurality of organization members, in a graphical user interface. Detailed information associated with each member of the organization, such as their experience, skills, and certifications, may be stored and displayed. Using such detailed information, the organization hierarchy application may identify one or more subjects of expertise for each member through a weighted analysis. An organization member with experience in c.p.r. and first aid certified may be automatically designated as an expert in an “emergency” subject. Additionally, users may manually designate specific employees as experts in one or more subjects. A department head may designate a technology officer as an expert in subjects such as “technical support” and “active directory”, and designate a patent attorney as an expert in subjects such as “intellectual property” and “patents.”

In the exemplary embodiment, users access the organization hierarchy application and input a query, such as a new topic or problem. Exemplary tasks or queries include “change my last name”, “broken internet connection”, “file a patent”, or “sexual harassment”. The application may analyze the input and identify one or more subjects matters associated with the problem. For example, the application may identify the subjects “legal” and “intellectual property” from a “file a patent” search query. Finally the organization hierarchy application may generate and display a list of one or more organization members with expertise in the identified subject matters.

### Illustrated Methods

Methods are described which may facilitate the quick discovery of subject matter experts within an organization for a specific issue. In one embodiment, an organization hierarchy application may compile and generate an organization hierarchy comprising a plurality of organization members. The organization hierarchy may be displayed in a graphical user interface.

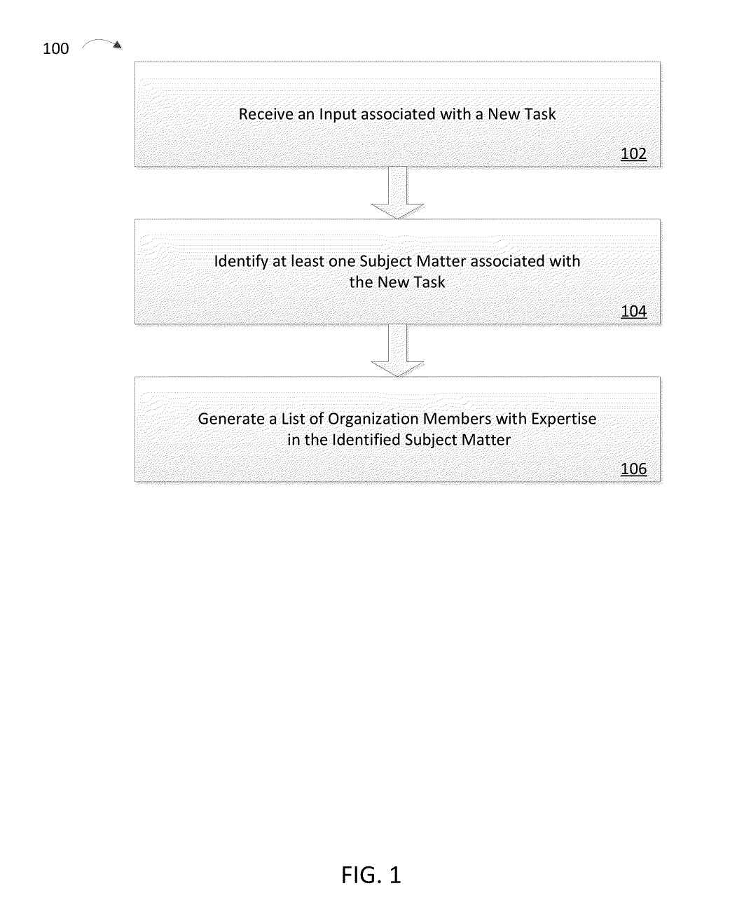

FIG. 1 is a flow chart illustrating a method according to an embodiment. As shown in FIG. 1, in step 102 of method 100, an input associated with a new task is received. The input may comprise a manual user input, such as through a keypad or microphone. As two examples, a user may enter text into a text field, or speak into a microphone to input a new task. Examples of new tasks include “file a patent”, “draft a complaint”, “change my last name”, or “fix my computer”.

Tasks or support queries may also be determined, or suggested, automatically. A new task may be determined, inferred, and/or suggested by analyzing an email, text message, meeting request, or calendar entry. As one example, an input associated with a new task may be determined based on a meeting request for “windows 8 migration”.

In step 104, at least one subject matter associated with the new task is identified. In one embodiment, a library of one or more subject matters may be used to match a new task with an existing subject matter. A subject matter library may be derived from the specific hierarchy or arrangement of an organization. In one example an organization comprises an IT department, a legal department, and a customer service department. Corresponding subjects may be derived from each department. Using such corresponding subjects, an organization hierarchy application may determine whether a new task is associated with “technical support” (i.e. the IT department), “legal” (i.e. the legal department), or “customer service” (i.e. the customer service department).

A subject matter library may be generated from standard, customary, and/or recurring subject matters. In a law firm, for example, customary or recurring subject matters may include “litigation”, “intellectual property”, “mergers and acquisitions”, or “labor and employment”. In a marketing firm, customer or recurring subject matters may include “print”, “video”, and “radio”.

After a user inputs a new task, a user may be asked to choose one or more suggested subject matters, for example, through a check-box interface. After a task is completed, a user may be prompted to associate one or more subjects with the completed tasks, thereby populating a library of subject matters.

Subject matters identified with the new task may be used to identify previously accomplished or inputted tasks. In one embodiment, after an input associated with a new task is received, one or more related tasks may be identified, and a list of related tasks may be displayed. For example, a user may input a new task entitled “create an advertising presentation.”

In step 106, a list of organization members with expertise in the identified subject matters is generated. The list may comprise zero, one, two, or more organization members. The list may be arranged according to one or more factors, such as the availability of an organization member, the relative expertise of the organization members in the identified subject matters, and/or the distance between the user and the organization members.

In one embodiment, the list of organization members may be influenced and/or filtered based on one or more factors in addition to subject matter expertise. Such factors may include, without limitation, location, availability, and/or recency. As one example, a user inputs a new task stating “complain about leaky faucet”. The subject matters “facilities” and “plumbing” may be identified from the new task. The list of organization members may comprise organization members with expertise in facilities and/or plumbing, but may be limited to organization members that are located in the same building or on the same campus as the user inputting the new task.

As another example, a user inputs a new task stating “draft a harassment complaint.” The organization hierarchy application may analyze the new task and identify the associated subject matters of “human resources” and “legal”. A list of organization members with expertise in “human resources” and/or “legal” may be generated.

In one embodiment, an organization member may be associated with one or more subject matters, or have one or more subject matters of expertise. Each subject matter that a member is associated with may be ranked, or graded. In one embodiment, an organization member is associated with the subject matters “java” and “perl”. The organization member may routinely work on java related projects, whereas the member's work with perl may be associated with older, completed projects. The java subject matter expertise for that organization member may have a high strength, or confidence level, while the perl subject matter expertise may be a lower strength or confidence level.

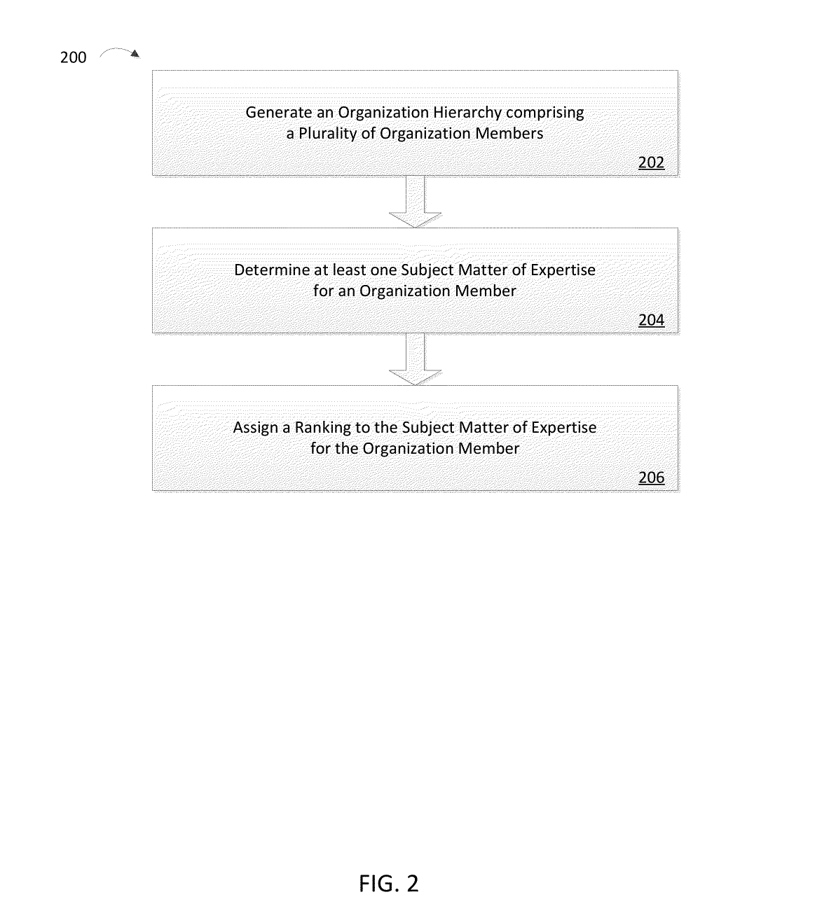

FIG. 2 is a flow chart illustrating a method according to another embodiment. As illustrated in FIG. 2, in step 202 of method 200, an organization hierarchy comprising a plurality of organization members is generated. In one embodiment, an organization hierarchy application generates an organization hierarchy. To create an organization hierarchy, the organization hierarchy application may gather, collect, and/or receive organization information associated with a plurality of organization members.

Hierarchical organizations may include business corporations, charitable organizations, partnerships, and teams. Such organizations may comprise a plurality of similar or different organization components, including organization members (e.g. people), organization resources (e.g. mobile devices, printers, conference rooms, offices, etc.), projects, and/or files. Each organization component may comprise one or more elements, or characteristics, such as a name, date (e.g. creation date, hiring date), and availability.

The information collected for each organization component may comprise a variety of social media, strategic, and/or hierarchical information. Basic directory information such as the name, title, email address, telephone number, and office location of an organization member may be collected. Other information may include pictures (e.g. headshots or personnel pictures), memberships (e.g. departments, teams, outside associations), skills, roles, direct reports, and other relationships. Some collected information may be strategic and/or hierarchical, such as hiring dates, salaries, production rating, and/or efficiency ratings of organization members. Information received about other types of organization components may include the resource's name, location, telephone number, access code, and/or age.

Information may be received from a directory service, such as Active Directory, Lightweight Directory Access Protocol (LDAP), Samba, Fedora Directory Server, OpenDS, or Apache Directory Server. In one embodiment, a large organization utilizes multiple Active Directory databases for tracking various objects such as security principles (e.g. users or user accounts) and resources (e.g. printers). Some or all of the information about the security principles and resources stored by the Active Directory databases may be collected and/or received by a server, such as an integrated services server.

An organization hierarchy comprising a plurality of organization members may be generated based on at least part on the organization information. In one embodiment, the integrated services server analyzes strategic, hierarchical, and social media organization information to generate an organizational hierarchy. The organizational hierarchy may reflect various relationships between organization members, such as dotted line relationships, supervisory relationships, mentor relationships, team memberships, team roles, and personal assistant contact preferences.

In step 204, at least one subject matter of expertise is determined for an organization member. In one embodiment, an organization hierarchy application analyzes each organization member of the plurality of organization member to determine one or more subject matters of expertise for each organization member.

A subject of expertise may be determined based at least in part on one or more elements of the organization member, such as that organization member's title, skills, experience, and/or education. In one example, an organization comprises a software corporation, with an organization member having the title of “web UI developer.” Based on an analysis of the web interface developer's profile (comprised of different components), the organization hierarchy application may determine that the web interface developer has subjects of expertise including programming and web development.

In one embodiment, an organization member may manually input one or more subjects of expertise. An organization member may record their own subjects of expertise, and/or subjects of expertise for other organization members. An organization member may manually record skills, expertise, and/or responsibilities with an organization hierarchy application by editing or updating an organization member profile. A team leader, department head, or human resources personnel may update organization member profiles to reflect subjects of expertise. Organization members may also be granted permissions to edit and update their own subjects of expertise.

In step 206, a ranking is assigned to the subject of expertise determined for the organization member. A ranking may comprise a confidence interval, or a value indicating the relative strength of that member's subject matter expertise, as compared to an absolute scale and/or other organization members. A ranking may be assigned based on one or recency, or how recently an organization member exhibited behavior associated with expertise in the subject. An organization member's ranking or strength of expertise for a subject matter may decrease over time, such that older designations and determinations of subject matter expertise have less weight than newer designations and/or determinations of expertise. As a subject matter ranking declines over time, a supervisor may be reminded to update a ranking or designation for that member's subject matters of expertise. Accordingly, the results generated from a support request or new task search stay fresh with the best matches for the task or request.

As one example of assigning ranking based at least in part on recency, an organization member is determined to have expertise in the subject of “marketing.” The determination of such expertise may be based on the educational history of the organization member, for example, her collegiate degree may be in marketing. Over time, however, the relevance of older organization member elements, such as education, may be diminished if that organization member does not list any more recent skills, certifications, or experience in that particular subject matter. Thus, an organization member who recently graduated with a degree in marketing maybe determined to have marketing as a subject of expertise, with a very high ranking. An organization member who graduated two decades ago with a degree in marketing, but currently works in information technology, may also be determined to have marketing as a subject of expertise, but with a much lower ranking.

A ranking may be assigned to a subject of expertise based on a weighting of different elements of an organization member profile. In one example, detailed information may be stored about each organization member, including title, skills, education, and experience (collectively “elements”). For purposes of determining subjects of expertise, the education component of an organization member may be ranked higher than the member's title (i.e. title component), but lower than the skills component and experience component of that organization member.

Methods and systems for identifying subject matter expertise across an organization hierarchy may allow users to manually designate one or more experts for a subject matter, task, and/or support query. A list of completed tasks or support queries may be generated for a user, with input fields for the user to quickly designate appropriate personnel, or subject matter experts, for handling similar tasks or support queries in the future.

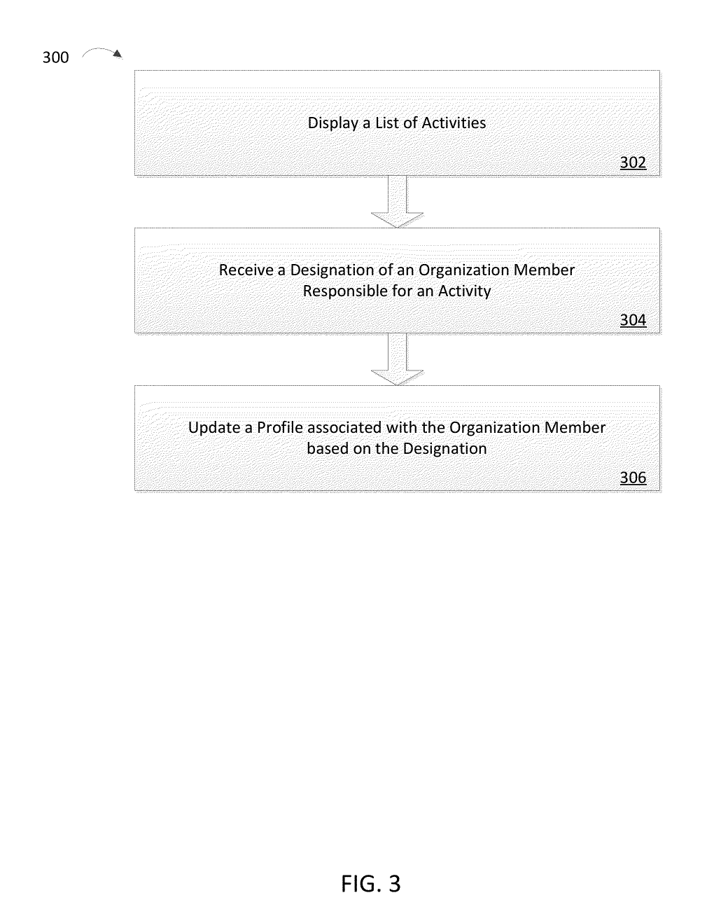

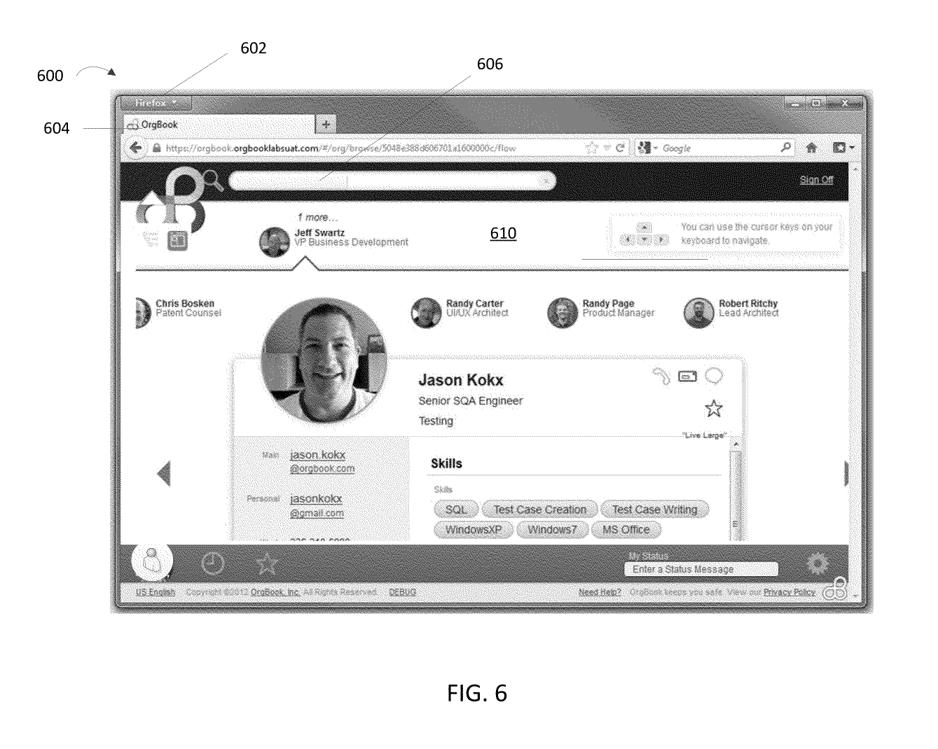

FIG. 3 is a flow chart illustrating a method according to another embodiment. As shown in FIG. 3, in step 302 of method 300, a list of activities is displayed. The list of activities may be displayed in a graphical user interface generated by an organization hierarchy application, such as illustrated in FIGS. 6-8.

Activities may comprise discrete tasks or actions performed by an organization (e.g. an activity performed by an organization member, a task accomplished by an organization team), or a list of support queries, requests, or questions, received by an organization. Other examples of activity may include goals, objectives, strategies, and/or plans created or implemented by an organization.

A list of activity may be generated based on data collected, or received, from one or more client devices. A client device may track activities, such as tasks or actions performed by the user on the client device. A list of activity may be generated from a default list of activities, for example, when a system is first initialized. A default list of activities may be created based on typical or routine activities associated with certain types of organizations. A list of recent activities for an accounting firm may include routine accounting processes, such as “initiate an audit”, or “begin tax return”.

Users may access the list of activity through an affordance, such as a designation icon, displayed by an organization hierarchy application. The list of activity may be filtered, or customized, according to the user. In one embodiment the list of recent activity may be filtered according to a permission level. For example, the recent activity of an organization member may be viewed by the member and that member's teammates and supervisors, but may not be accessed or viewed by unrelated organization members in a different department. In a similar manner, managers or supervisors may have a permission level granting them access to the recent activity of everyone under their authority. In some embodiments filtering a list of recent activity according to a permission level may result in a list of activity inherently filtered by department or even by subject.

The list of recent activity may be filtered according to other factors, such as recency/timeliness/date, location, strategic designation, member, or team. As one example, a department head may desire to view the recent activities of a specific team in their department, rather than viewing the recent activity of their entire department. As another example, a department head may desire to view the most recent actions or objectives accomplished by their department, or support requests occurring over a specific period, such as weekends, holidays, or Mondays.

A list of recent activity may also be filtered according to rating, such as how well the activity was accomplished. As one example, each support request may be rated by an end user. The list of activity may be filtered according to the lowest rated support requests, as these requests may require the most immediate attention for fixing. Filtering, or sorting the list of recent activities may allow managers to quickly view relevant activity information without having to navigate through unrelated support queries.

In step 304, a designation of an organization member responsible for a support query is received. The designation may comprise one, two, or more organization members. For example, a user may designate one specific organization member as being responsible for one support query, and designate an entire team as being responsible for another support query. In an example, a department head may designate various department members as responsible to, or an expert in, one or more of the listed support queries. One or more subject matters may be identified from a support query. When an organization member is designated as being responsible for that support query, the organization member may be designated as a subject matter expert for any subject matters identified from the support query.

In step 306, a profile associated with the organization member is updated based on the designation. If a team or department is designated for an activity, than each profile associated with each team member or department member may be updated. In one embodiment, one or more subject matters are identified from the activity. The profile may then be updated with the identified subject matters.

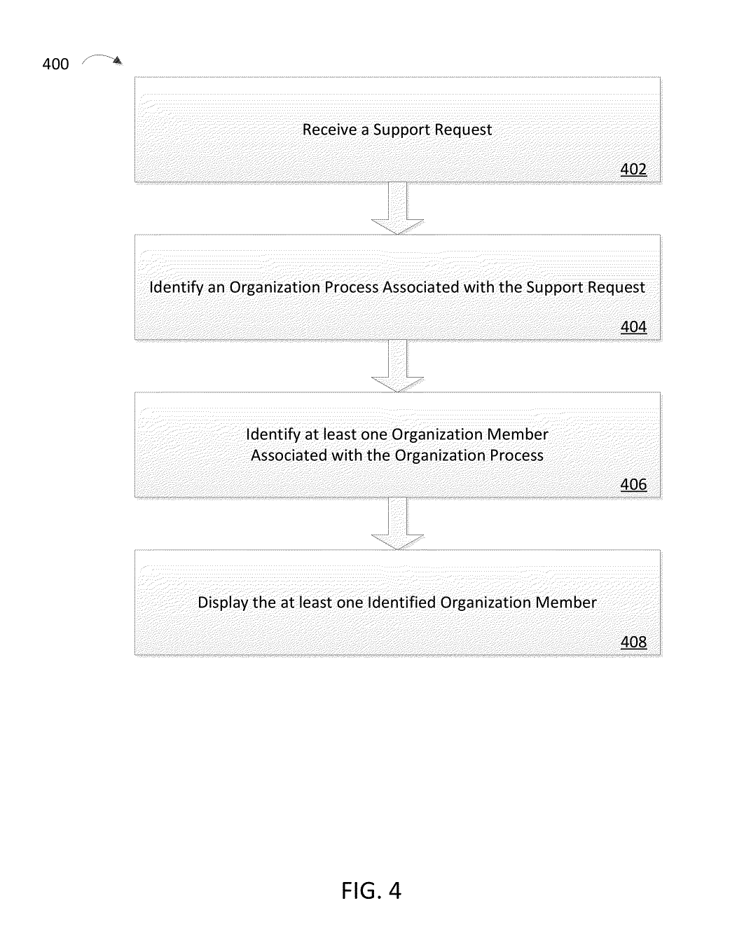

FIG. 4 is a flow chart illustrating a method according to another embodiment. As shown in FIG. 4, in step 402 of method 400, a support request is received. In one embodiment, a user may be logged in to an organization hierarchy application, and submit a support request directly through the organization hierarchy application. In another embodiment, a user may submit a support request through other mechanisms, such as by submitted a support request through email, web forum, or by speaking with a customer support representative.

In step 404, an organization process associated with the support request is identified. One or more organization processes may be associated with a support request, and may be identified.

In step 406, at least one organization member associated with the identified organization process is identified. In one embodiment, a support request may be analyzed and compared with a library of stored organization processes. The support request may be matched with one or more of the stored organization processes.

In step 408, the at least one identified organization member is displayed. Identified organization members may be displayed as a list of matching organization members. In one embodiment, the list of matching organization members may comprise one or more organization members with the highest ranking expertise in the identified organization process. The list may be generated by analyzing the ranking of each organization member for the identified processes. Each organization member included in the list may meet or exceed a threshold expertise, or expertise rating.

In another embodiment, no organization members may have expertise in any of the identified processes. In one such embodiment, a list of organization members may be generated based on other factors, such as highest overall satisfaction rating, or highest availability. In this manner, when no organization member meets a threshold expertise for a particular support request, customers may be given the option to choose among highly rated support personnel and/or support personnel with the shortest wait time.

### Illustrated System

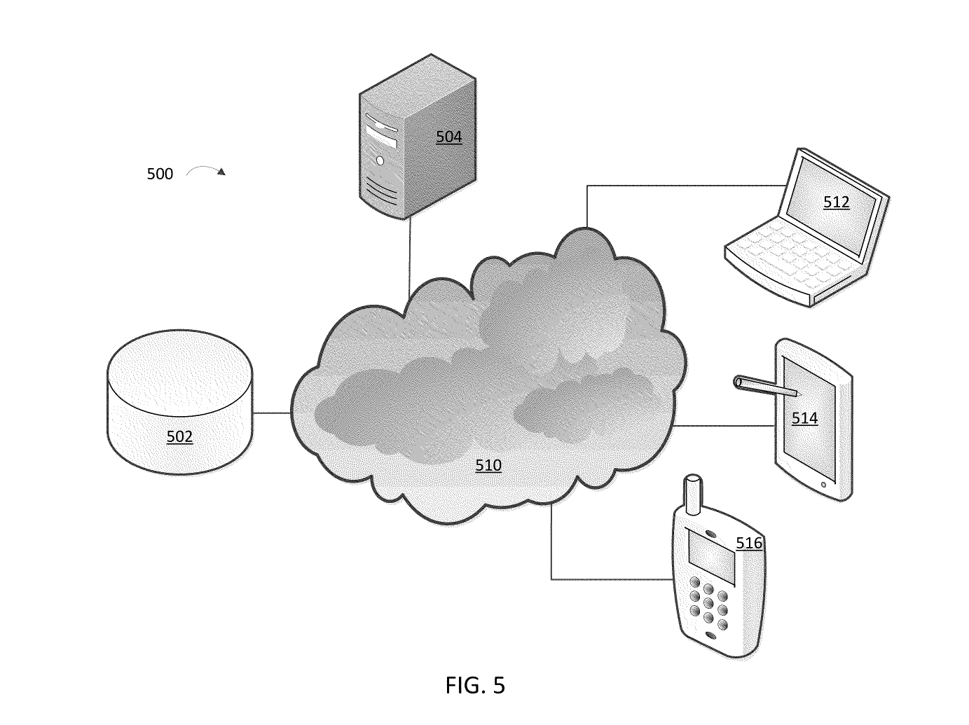

FIG. 5 is a diagram illustrating a system according to an embodiment. System 500 comprises data store 502, server 504, and client devices 512, 514, 516. Server 504, data store 502, and client device 512 may be in communication over network 510. Data store 502 may comprise one or more repositories for data, such as one or more databases. Non-limiting examples of data store 502 include an Active Directory database and a corporate directory. Organization information, such as information associated with a plurality of organization members, may be stored on data store 502. Server 504 may receive organization information from data store 502 and generate an organization hierarchy.

As illustrated in FIG. 5, client device 512 comprises a personal computer, client device 512 comprises a tablet computer 514, and client device 516 comprises a smart phone 516. In other embodiments, other types of devices may be used. Client devices 512, 514, 516 may be configured to generate a graphical user interface, and execute an application within the graphical user interface, such as an organization hierarchy application. Applications operating on client devices 512 may comprise native mobile device applications such as an iOS iPad application, a Windows Phone application, or an Android application. As one alternative, an application operating on a client device 512 may comprise a web application accessed through a web browser. In one embodiment, client devices 512, 514, 516 display an organization hierarchy application within a graphical user interface, such as in the native operating system, or within a web browser.

### Illustrated Screenshots

FIGS. 6-8 are screenshots illustrating embodiments for identifying subject matter expertise across an organization hierarchy. According to the illustrations, FIGS. 6-8 comprise respective screenshots 600, 700, 800 of web application 604 executing in web browser 602. As shown in FIGS. 6-8, web browser 602 comprises the Firefox web browser. The web application may execute in other browsers, such as Chrome, Safari, and/or Internet Explorer. In other embodiments, an application may comprise a native application, such as an iPad application, Windows Phone application, or Android application, operating on a tablet, smart phone, or other device. Web application 604 may comprise an organization hierarchy application that generates an organization hierarchy from organization information, and displays the organization hierarchy in a graphical user interface.

Web application 604 may generate an organization hierarchy comprising a plurality of organization members, and display the organization hierarchy in organization view 610. As shown in FIG. 6, web application 604 generates an organization hierarchy, displayed in organization view 610. An organization hierarchy may comprise one or more organization components such as organization members, organization resources (e.g. conference rooms, buildings, devices), and organization files (e.g. word processing documents, spreadsheets, etc.). Web application 604 may display organization components in other views, such as a directory view, recents view, and/or favorites view.

Web application 604 further comprises search affordance 606. A new task or support query may be entered, or input, into search affordance 606. Users may input a new task or support query through a directed search or undirected search. In a directed search embodiment, a user may specify they are inputting a new task as part of the search affordance input. For example, a user may input a new task or query by preceding the task or query with specific antecedent text, such as “task:” or “support:”. By using an antecedent string, a user may signal to the application that they are looking to solve a new task.

A new task or support query may be input in a less directed fashion. An organization hierarchy application may interpret certain characteristics of a string entered into search bar 606 as a signal indicating a new task or support query. For example, a user may input “who do I talk to about a bad phone connection?” into search bar 606. The application may determine that a question mark signals a new support query. In another example, a user may input “draft patent application” into search bar 606. The application may determine that certain types of text input into search affordance 606, such as verbs like “draft” or “create” may be more likely to be associated with creating a new task, than other types of text input, such as proper and/or common nouns like “html” or “marketing.”

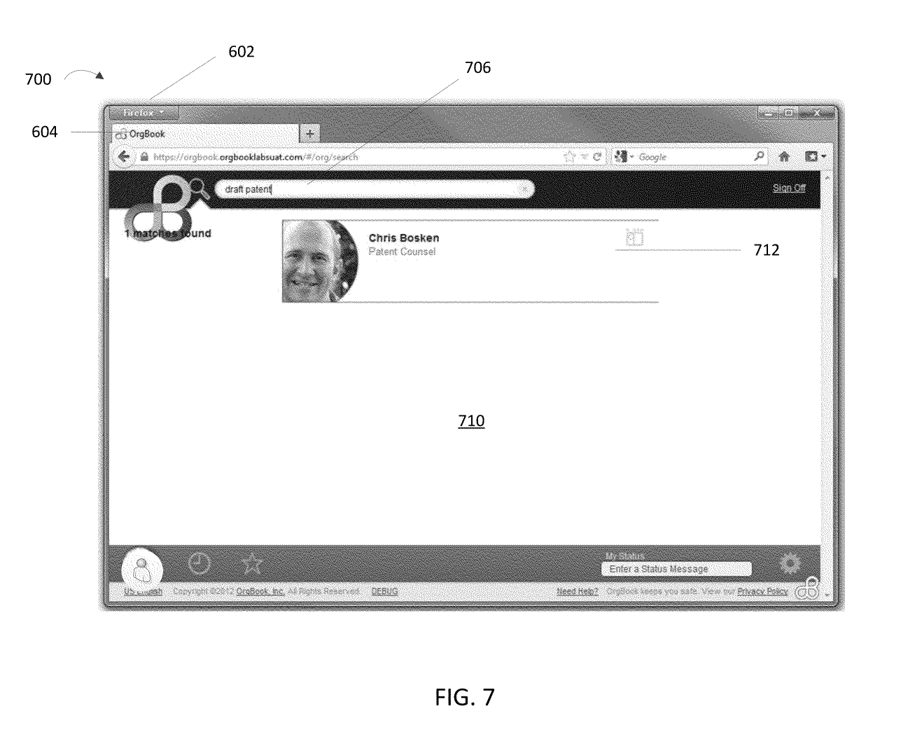

In FIG. 7, a user inputs a new task into search affordance 606 entitled “draft patent.” Web application 604 may identify at least one subject matter associated with the new task, and generate a list of organization members with expertise in the identified subject matter(s). The list of organization members is displayed in view 710, illustrated in FIG. 7 as matching organization member 712.

The list of organization members may comprise zero, one, two, or more organization members. In some scenarios, an organization may have no member with expertise in a subject matter. If no members have relevant expertise, than the application may prompt the user to manually input a subject matter associated with the new task.

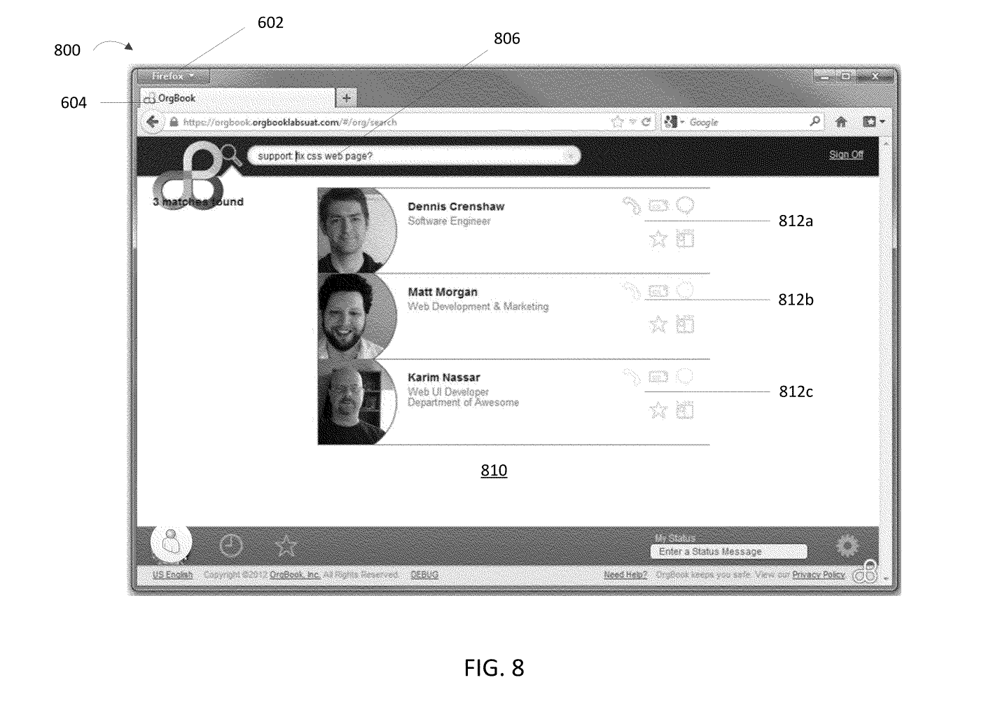

In FIG. 8, a user inputs a support request entitled “support: fix css web page?” into search affordance 806. Web application 604 may identify subjects such as “css” and “web development” from the inputted new task, and generate a list of organization members with expertise in “css” and/or “web development”. As shown in FIG. 8, organization hierarchy application 604 generates a list of three matching organization members 812a, 812b, 812c, and displays the list of matching organization members in view 810. Users may then easily choose, or contact, one of the matching organization members to immediately begin work on the support request.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

What is claimed is:

1. A method for identifying subject matter expertise across an organization hierarchy, the method comprising the steps of:
receiving a support request;
identify an organization process associated with the support request;
identify at least one organization member associated with the identified organization process; and
displaying a list of organization members with the highest ranking expertise in the identified organization process.

2. A method for designating subject matter expertise across an organization hierarchy, the method comprising the steps of:
identifying at least one organization process;
displaying the identified organization process;
receiving a designation of at least one organization member;
associating the designated organization member with the identified organization processes;
updating a profile associated with the organization member based on the designation.

3. The method of claim 2, wherein displaying the identified organization process comprises displaying a list of activity

4. The method of claim 3, wherein the list of activity comprises a list of recent activity.

5. The method of claim 3, wherein an activity comprises a support query, a task, or a business process.

6. The method of claim 3, further comprising:
filtering the list of activity according to permission level, ranking, recency, location, strategic designation, member, or team, and wherein displaying a list of activity comprises displaying the filtered list of activity.

7. The method of claim 2, wherein the designation of an organization member comprises a designation of an organization team or department.

8. The method of claim 2, further comprising:
identifying one or more subject matters associated with the organization process, and wherein the profile is updated with the one or more identified subject matters associated with the organization process.

9. A method for identifying a subject matter expert across an organization hierarchy, the method comprising the steps of:
receiving an input associated with a new task;
identifying one or more subject matters associated with the task; and
generating a list of organization members with expertise in the identified subject matters.

10. The method of claim 9, further comprising:
displaying the list of the one or more organization members.

11. The method of claim 9, wherein identifying one or more subject matters associated with the task comprises matching a task with at least one of a plurality of subject matters in a subject matter library.

12. The method of claim 9, further comprising:
identifying one or more related tasks to the new task based at least in part on the identified subject matters.

13. A method for identifying a subject matter expert across an organization hierarchy, the method comprising the steps of:
generating an organization hierarchy comprising a plurality of organization members;
determining a subject of expertise for a first one of the plurality of organization members; and
ranking the subject of expertise.

14. The method of claim 13, wherein ranking the subject of expertise is based at least in part on recency.

15. The method of claim 13, wherein determining a subject of expertise for a first one of the plurality of organization members comprises receiving a designation of the subject of expertise.
